(19) United States
(12) Patent Application Publication
(10) Pub. No.: US 2012/0204528 A1
(43) Pub. Date: Aug. 16, 2012

(54) HIGH SPEED CORN ROW UNIT DECK PLATES

(75) Inventor: Bernard D. Regier, Newton, KS (US)

(73) Assignee: AGCO CORPORATION, Duluth, GA (US)

(21) Appl. No.: 13/336,473

(22) Filed: Dec. 23, 2011

Related U.S. Application Data
(60) Provisional application No. 61/426,761, filed on Dec. 23, 2010.

(51) Int. Cl. A01D 45/02

(52) U.S. Cl. 56/62

(57) ABSTRACT

A curved stripper plate for a row unit of a harvesting header. The stripper plate removes useable parts from crop stalks gathered in a crop passage. In one embodiment, the stripper plate is arched thereby providing an upwardly curved edge along a crop passage of the row unit.

### CROSS REFERENCE TO RELATED APPLICATIONS

The present application claims the benefit of co-pending U.S. provisional application entitled “HIGH SPEED CORN ROW UNIT DECK PLATES (P1150H)”, having Ser. No. 61/426,761, filed Dec. 23, 2010, which is incorporated herein by reference in its entirety.

### TECHNICAL FIELD

This invention relates to cutting and gathering stalk crops such as corn with a header coupled to an agricultural vehicle.

### BACKGROUND

Agricultural harvesters such as combines are typically equipped with a harvesting header. Corn headers are specifically designed to pick corn and vary in size from two-row units to twelve-row units or more. As the harvester moves through the field, each row-unit passes between rows of corn. Corn header row units typically use gathering chains to covey crop material and ears rearward toward a cross auger. A set of driven snap rolls, which rotate based on the speed of the harvester, grabs the corn stalks and forces them downward between deck plates. The deck plates are sometimes referred to as stripper plates. The ears of corn are snapped free of the stalk and the cross auger passes the ears to the feeder housing of the harvester. If the snap rolls are operated too fast or too slow, ears of corn may be lost or entire corn stalks may be passed to the cross auger and feeder housing.

Also, if it is desirable to run the corn header fast, the snap rolls typically also run fast which pulls the corn ears into the stripper plates fast. This causes butt shelling which is undesirable. What is needed is a simple and cost effective stripper plate configured to allow corn ears to decelerate as they are stripped off the stalk while the header is running fast to harvest a large mass of crops.

### BRIEF DESCRIPTION OF THE DRAWINGS

The accompanying drawings, which are incorporated in and constitute a part of this disclosure, illustrate various embodiments of the present invention. In the drawings:

FIG. 1 shows a perspective view of a corn header having a plurality of row units for an agricultural vehicle;

FIG. 2 shows a top view of the header of FIG. 1;

FIG. 3 shows a close-up view of a portion of the header of FIG. 1;

FIG. 4 shows a perspective view of a row assembly having a pair of augers cooperating with a pair of curved stripper plates;

FIG. 5 shows an end view of the augers and stripper plates of FIG. 4;

FIG. 6 shows a top view of the augers and stripper plates of FIG. 4;

FIG. 7 shows an end view of a single auger and a pair of curved stripper plates

FIG. 8 shows a perspective view the auger and stripper plates of FIG. 7;

FIG. 9 is a top view of the auger and stripper plates of FIG. 7;

FIGS. 10 and 11 show a pair of curved stripper plates and opposing snap rolls stripping ears of corn from a stalk;

FIG. 12 shows a pair of offset curved stripper plates and offset snap rolls stripping ears of corn from a stalk;

FIG. 13 shows a pair of offset curved stripper plates, a snap roll and an idler for striping ears of corn from a corn stalk;

FIG. 14 shows a pair of offset curved stripper plates, a snap roll, and a pair of idler rolls for stripping ears of corn from a corn stalk;

FIG. 15 shows a pair of vertically offset curved stripper plates and having offset snap and idler rolls for stripping ears of corn from a corn stalk; and

FIG. 15 shows a pair of vertically offset stripper plates each having curved edge portions and flat portions for stripping ears of corn from a corn stalk.

### DESCRIPTION OF EXAMPLE EMBODIMENTS

The present invention may take many different forms. While the drawings illustrate and the specification describes certain preferred embodiments of the invention, it is to be understood that such disclosure is by way of example only. There is no intent to limit the principles of the present invention to the particular disclosed embodiments. References hereinafter made to certain directions, such as, for example, “left” and “right”, are made as viewed from the front looking rearward.

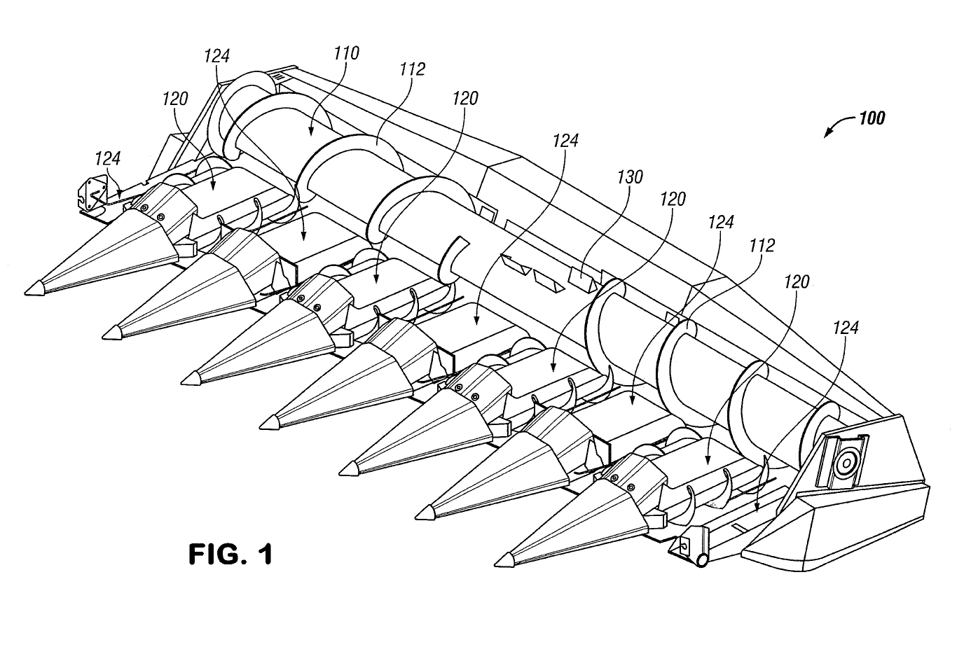

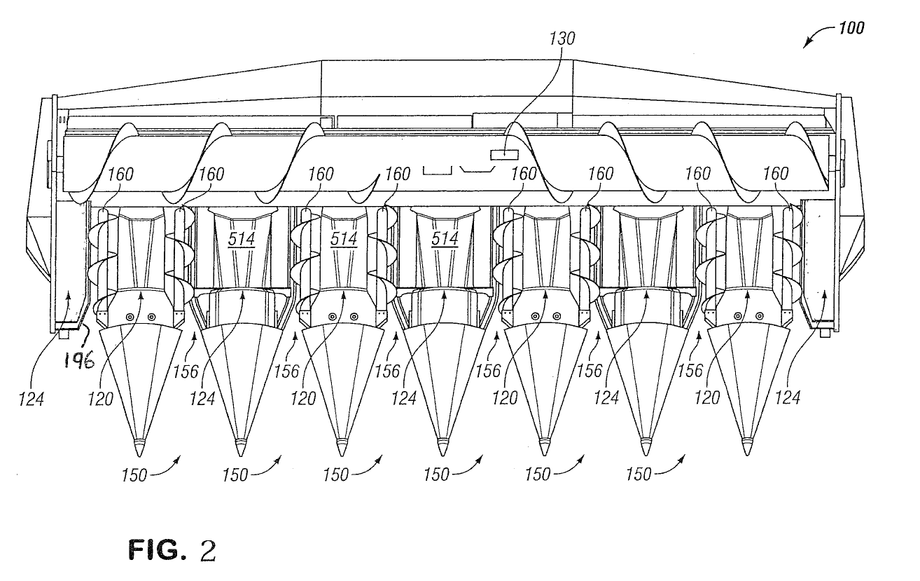

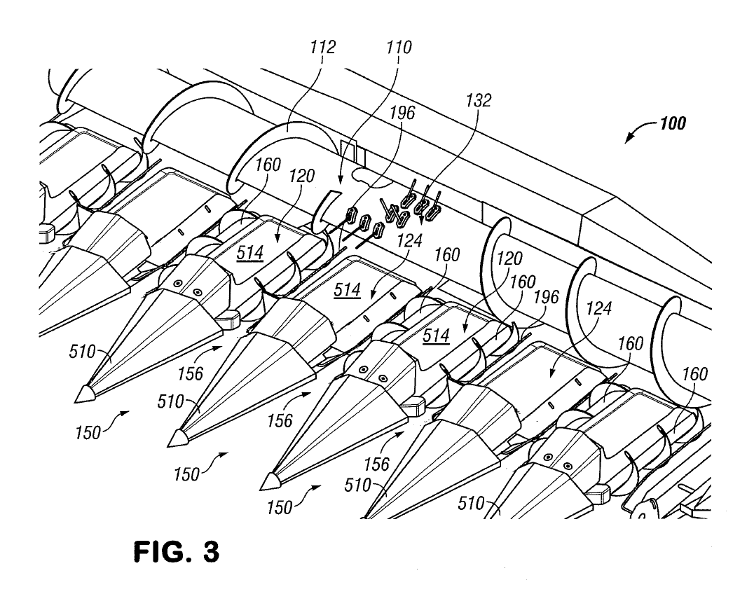

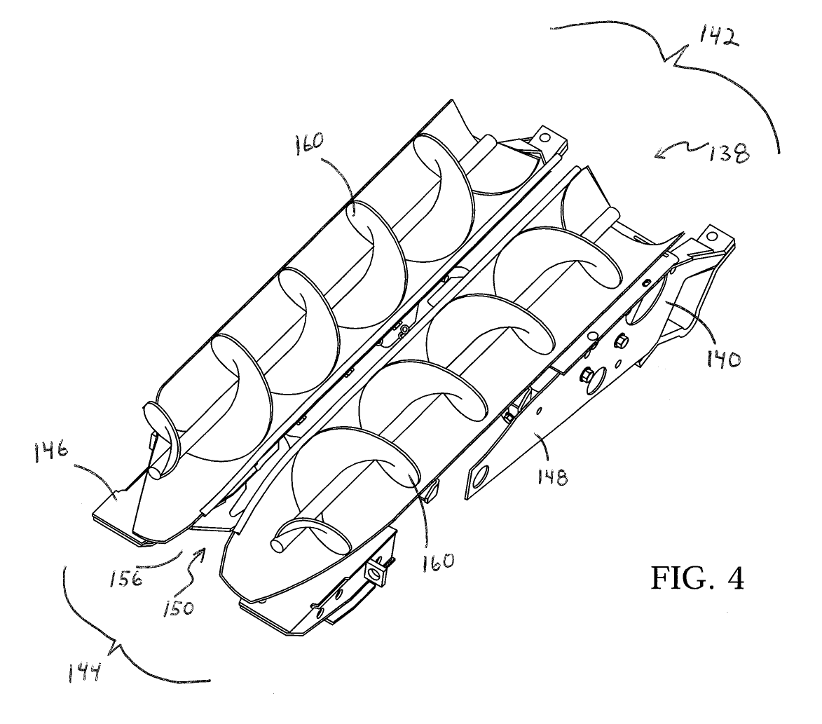

The exemplary header 100 selected for illustration in FIGS. 1-3 has a cross auger 110 with spiral flighting 112 for sweeping the ears of corn toward the center of the header 100. Large cross augers 110 may also have paddles 130, fingers or some other means to facilitate the delivery of the crop rearward to the feeder housing of a harvester. The header 100 has a plurality of forward-extending row units. The row units may have gathering chains and tensions to gather crop stalks in the crop passage 156 or instead have gathering augers 160 to convey stripped crops rearward. Headers utilizing gathering augers 160 have a plurality of live row-units 120 that include the gathering augers 160 that cooperate with a plurality of forward-extending dead row units 124. The dead row units 124 generally do not have powered components. The row units 120, 124 are arranged relative to one another so that the row units 120, 124 alternate relative to each other along the length of the header 110. The row units and the cross auger 110 define a feeder plane therebetween where useable parts of stalk crops are conveyed rearward from the row units 120, 124 to the cross auger 110. The row units 120, 124 may have a removable snout or divider 510 hingedly coupled to the front of each of the row units 120, 124. The row units 120, 124 also include a cover 514.

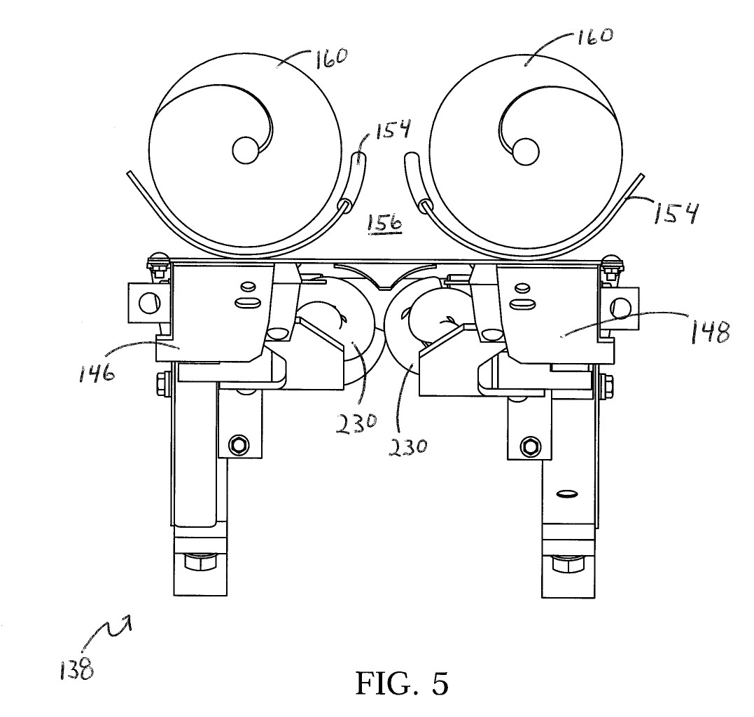

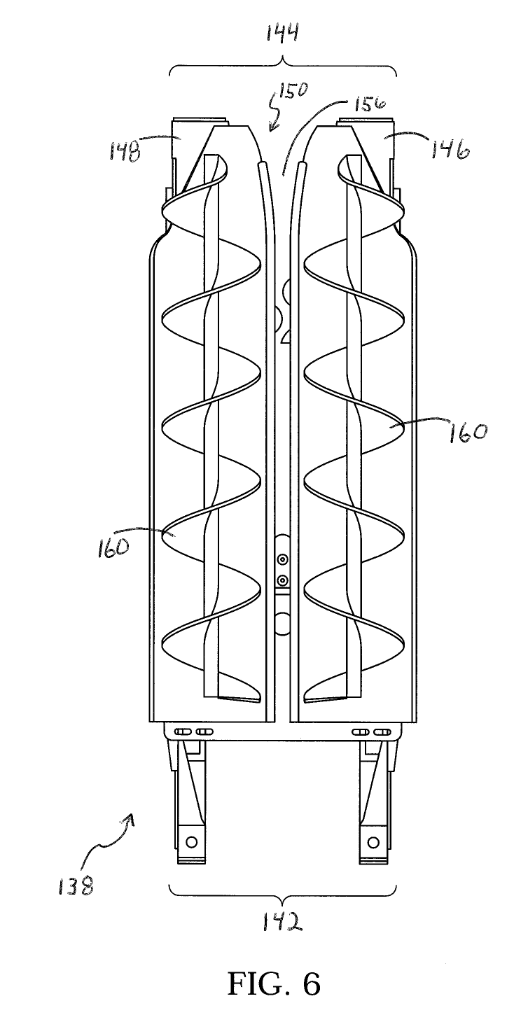

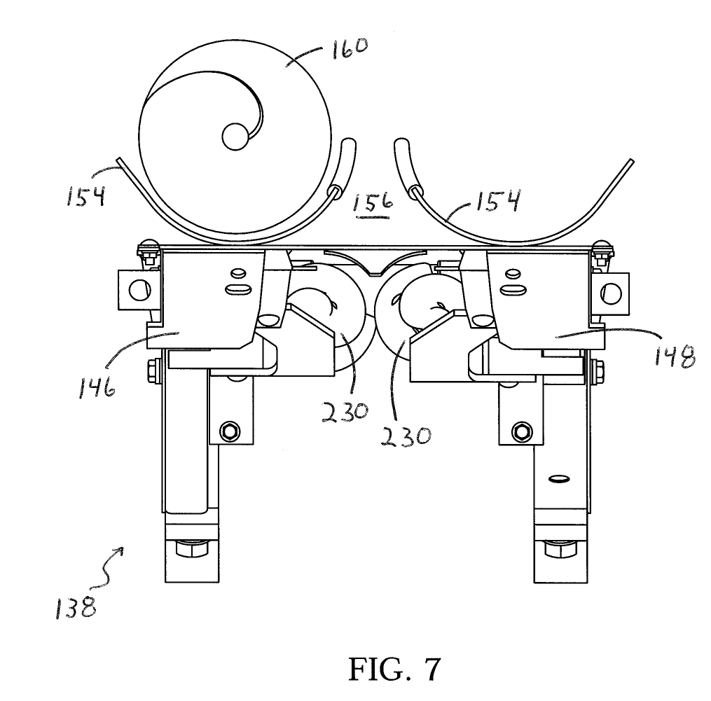

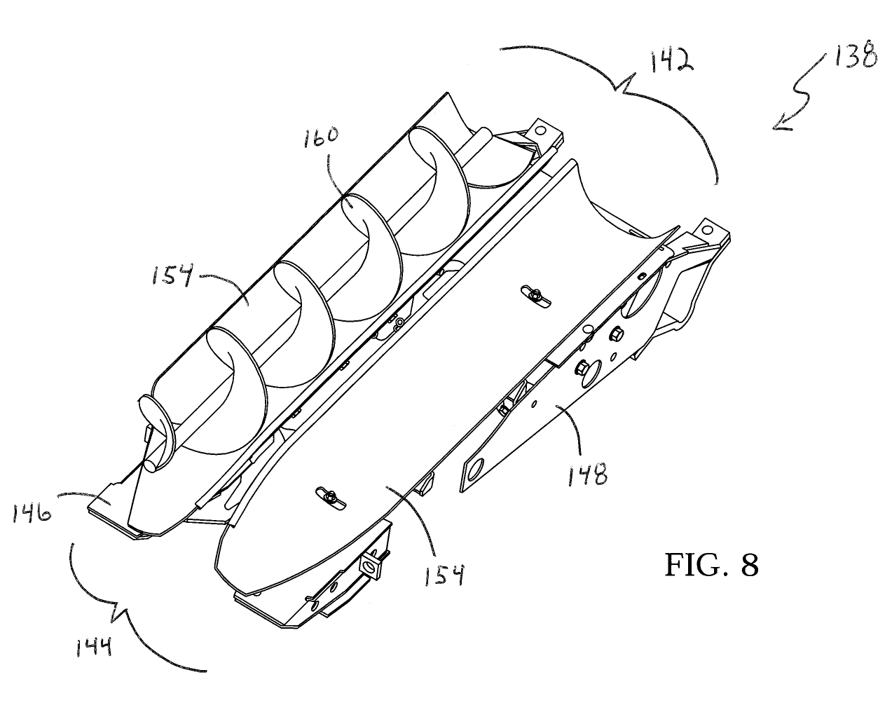

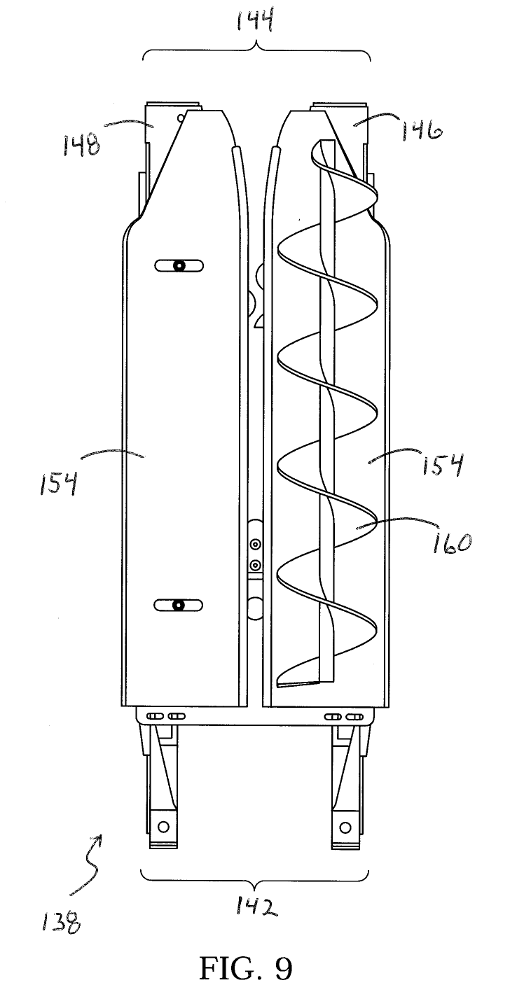

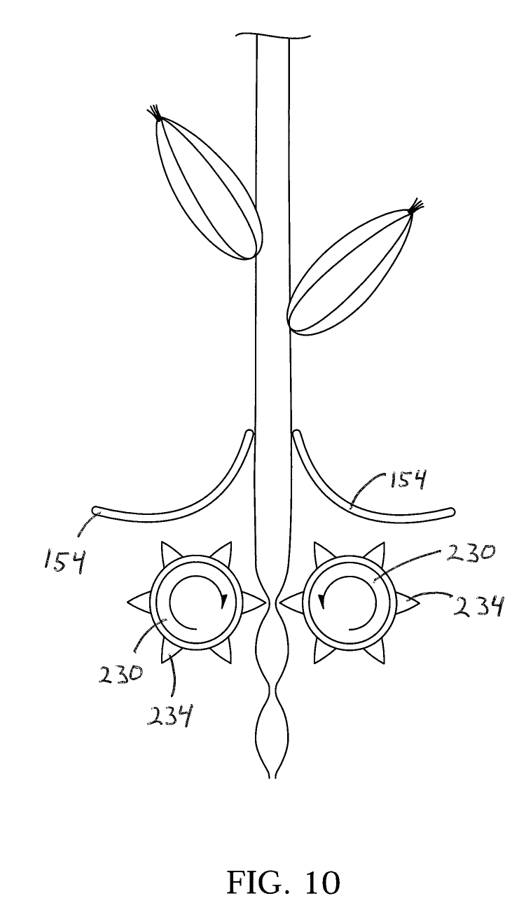

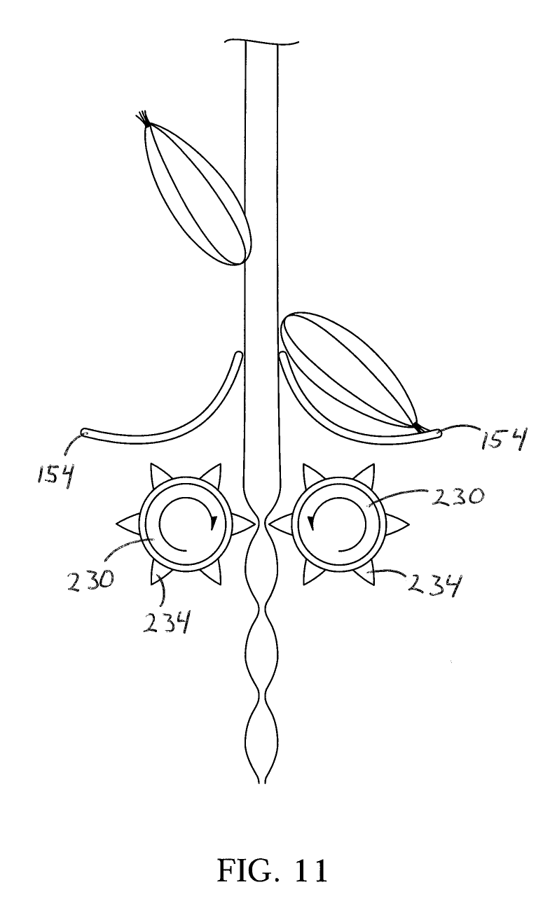

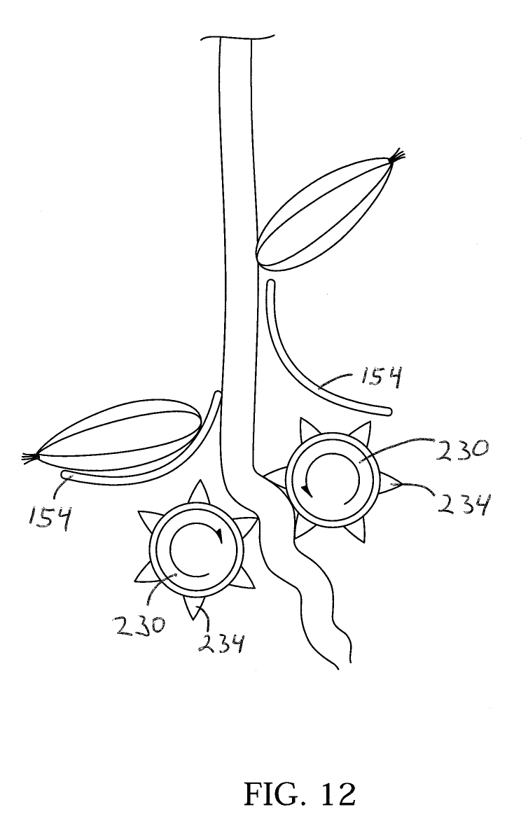

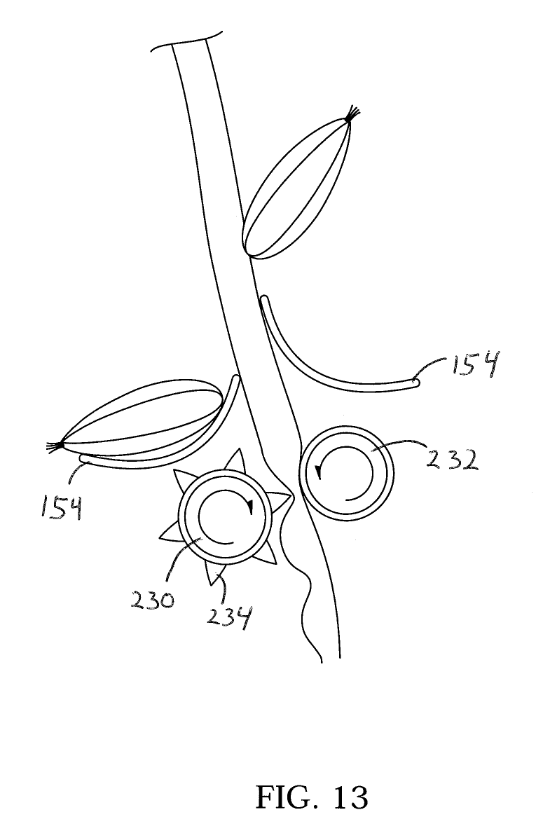

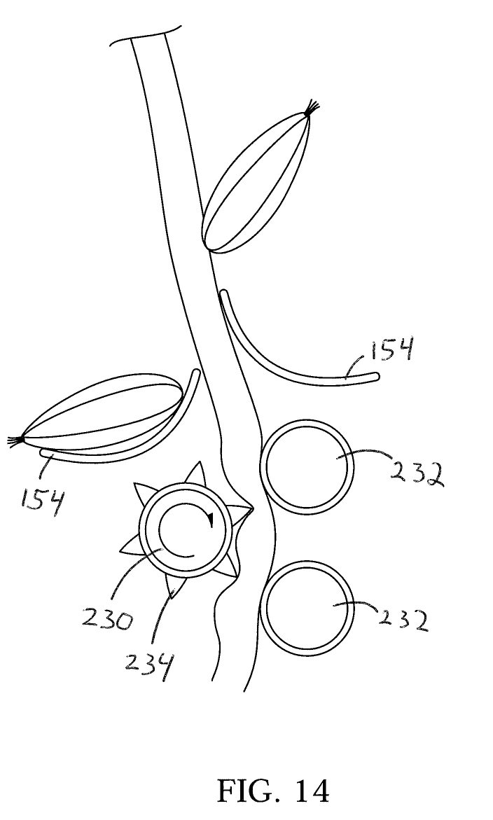

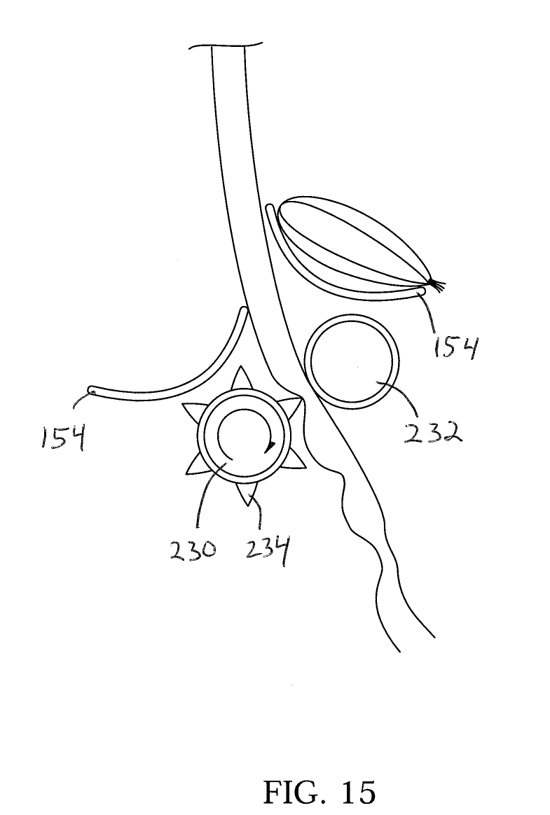

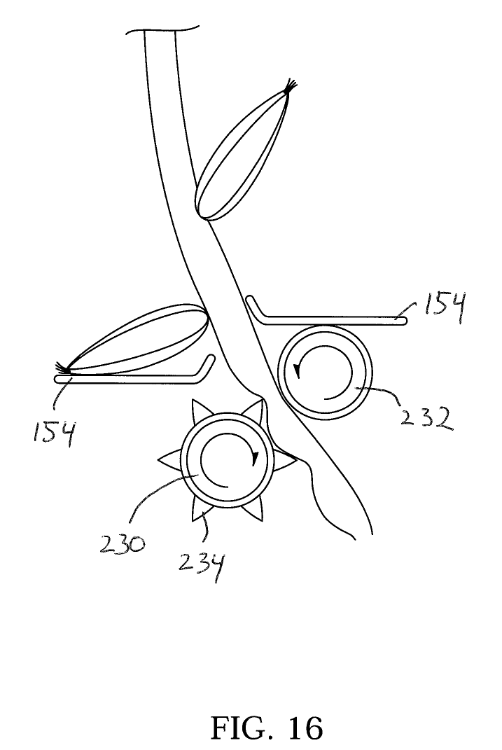

FIGS. 4-9 illustrate a row assembly 138 with one or more gathering augers 160 and a frame 140 having a back end 142 and a forward end 144. Half of the frame 140 forms part of a live row unit 120 and the other half forms part of a dead row unit 124. Therefore, one live row unit 120 includes two halves of two separate and adjacent frames 140. One dead row unit 124 includes two halves of two separate and adjacent frames. Each frame 140 includes a first portion 146 and a second portion 148 which are spaced from one another and protrude outwardly and forward from the back end 142. At the front and between adjacent row units 120, 124 is a crop entry 150 for receiving the stalks of the crop. The first and second portions 146,148 include stripper plates 154 which cooperate with one another to define a crop passage 156 between adjacent row units 120, 124. The stripper plates 154 strip useable parts such as ears of corn from crop stalks that are received in the crop passage 156.

At least one of the stripper plates 154 has an upward oriented or upward curved crop separating edge but preferably is arched generally in a downward manner across their lateral widths to provide a deceleration surface for the stripper crop to follow or slide down along immediately after being stripped from the stalks. The downward arch or the upward oriented edge portion preferably extends the full length of the strip plate 154 but may instead only extend part of the length of the stripper plate 154. In some embodiments the flighting of the gathering auger 160 determines the extent which a corresponding stripper plate 154 is arched because the stripper plate 154 cooperates with the gathering auger 160 to convey the striped crops rearward to the cross auger 110. The arch of one of a pair of opposing stripper plates 154 may be deeper compared to the arch of the other stripper plate 154 of the pair of opposing stripper plates 154. However, in some embodiments a portion of the stripper plate 154 may remain flat as shown in FIG. 16.

In one or more embodiments, the stripper plates 154 may have openings or elongated slots for receiving fasteners to secure the stripper plates to the frame and to allow the stripper plates 154 to be adjustable to vary the width of the crop passage 156. Because the stripper plates 154 are arched, the adjusting the distance between opposing stripper plates 154 defining a crop passage also adjusts the height of the crop separating edge.

In embodiments utilizing gathering chains, the stripper plates may be positioned above the gathering chains or alternatively be placed underneath the gathering chains.

Underneath the stripper plates 154 of each frame 140 are one or more snap rolls. At each crop passage 156 there is preferably one driven snap roll 230 on one side of the crop passage 156 and one or more undriven idler rolls 232 opposing the snap roll 230 from the other side of the crop passage 156. Instead of idler rolls 232, snap rolls 230 can oppose one another across the crop passage 156. Angled bearing supports may be used to mount the snap rolls and idler rolls to the frames.

Preferably, the powered snap rolls 230 include knives 234. If the idler roll 232 where to be powered it could be powered at a slower speed than an opposing snap roll 230. Also, the idler roll 232 could be adjustable relative to the side of the frame 136 of a dead row unit 124 so that it could be moved closer to the snap roll 230 for stalk chopping or moved away when reduced stalk chopping is desired.

When using gathering augers 160 it is desirable to bias the crop stalks in the crop passage 156 with the snap rolls 230 and idler rolls 232 toward the gathering auger 160. Idler rolls 232 are preferably offset from their opposing snap roll 230 in that the snap roll 230 and idler rolls 232 are at different heights or different distances from the ground so that the corn plant is not pulled straight down or in other words is pulled down at other than a perpendicular angle to the ground. If utilizing a pair of idler rolls 232 to oppose the snap roll 230, upper and lower idler rolls 232 are positioned so that the axis of rotation of the driven roll 230 is vertically between but horizontally offset from the axis of rotation of each idler roll 232. The axes of rotation of both idler rolls 232 are preferably both parallel and vertically aligned with each other because the idler rolls 232 are at different distances from the ground relative to each other.

One or more idler rolls 232 vertically offset from their opposing and corresponding snap roll 230 helps to lean or urge the corn plant toward the gathering auger 160 which is positioned on one side of a live row unit 120. Also, in one or more embodiments, the stripper or deck plates 154 may also be offset from one another relative to the ground to urge the crop to the side of the crop passage 156 with the gathering auger 160. In some embodiments, the arch of the higher of two opposing stripper plates 154 may be shallower than the arch of the lower of the two opposing stripper plates 154. Alternatively, the arch of the higher of the two opposing stripper plates may be deeper than the arch of the lower of the two opposing stripper plates 154. Improved cutting action is achieved by running the knives 234, also commonly referred to as flutes or bars, of the powered snap rolls 230 in close proximity to the one or more opposing idler rolls 232. A pair of idler rolls 232 cooperating with one another to oppose a snap roll 230 further increase the cutting and chopping ability by enhancing the engagement of the stalks in the knives 234 of the snap roll 230.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. In an attachment for a harvester having a cross auger, a forward-extending first row unit comprising at least one stripper plate, said stripper plate at least partially defining a crop passage for removing ears of corn from corn stalks gathered in said crop passage, wherein at least a portion of said stripper plate is arched generally downward.

2. The row unit of claim 1 wherein said stripper plate has an upward oriented edge at least partially defining said crop passage.

3. The row unit of claim 1 wherein said stripper plate is arched across its lateral width.

4. The row unit of claim 1 wherein said stripper plate has an upward curved crop separating edge.

5. In an attachment for a harvester having a cross auger, a forward-extending first row unit comprising a first stripper plate, said first stripper plate at least partially defining a first crop passage for removing ears of corn from corn stalks gathered in said first crop passage, wherein said first stripper plate has an upward curved edge.

6. The first row unit of claim 5 in combination with a second row unit, said second row unit comprising a second stripper plate having an upward curved edge and opposing said upward curved edge of said first stripper plate of said first row unit to further define said first crop passage between said first and second row units.

7. The first row unit of claim 5 wherein said first stripper plate is arched.

8. The first row unit of claim 5 wherein a portion of said first stripper plate is arched to define said upward curved edge.

9. The first row unit of claim 5 further comprising a gathering auger and said first striper plate cooperating with said gathering auger to convey striped ears of corn rearward.

10. The first row unit of claim 5 wherein said first stripper plate extends the length of said first row unit.

11. The first row unit of claim 5 wherein said upward curved edge extends the length of said first stripper plate.

12. The first row unit of claim 5 wherein said first stripper plate has a flat portion.

13. The first row unit of claim 5 wherein said first stripper plate has slots for receiving fasteners and said first stripper plate is adjustable in said slots to vary said first crop passage.

14. A stripper plate for a row unit of a harvesting header, at least a portion of said stripper plate configured to have a downward arch defining an upward crop separating edge at a crop passage for gathering crop stalks.

15. The stripper plate of claim 14 in combination with a gathering auger, said stripper plate and said gathering auger cooperating with one another to convey stripped crops rearward.

16. The striper plate of claim 14 in combination with another stripper plate defining said crop passage, said stripper plates offset from one another relative their distance from the ground.

17. The stripper plates of claim 14 wherein one of said stripper plates has a shallower arch than the other.

18. The stripper plates of claim 16 wherein the arched portion of the higher of said stripper plates in shallower that the other stripper plate.

19. The stripper plates of claim 16 wherein the arched portion of the higher of said stripper plates is deeper than the other stripper plate.
